(19) United States
(12) Patent Application Publication
(10) Pub. No.: US 2006/0078690 A1
(43) Pub. Date: Apr. 13, 2006

(54) Plasma chemical vapor deposition methods

(76) Inventors: Sunsoo Lee, Youngtong-gu (KR); Haemoon Lee, Youngtong-gu (KR); Yeonhong Jee, Suwon-city (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/045,061

(22) Filed: Jan. 31, 2005

(30) Foreign Application Priority Data
Oct. 13, 2004 (KR) 2004-81935

(51) Int. Cl. H05H 1/24

(52) U.S. Cl. 427/569

(57) ABSTRACT

A plasma chemical vapor deposition (CVD) method is for depositing a metal layer. In the plasma CVD method, a metal source gas is pre-injected into a chamber containing a substrate, and thereafter a plasma is formed in the chamber to deposit the metal layer on the substrate.

### BACKGROUND OF THE INVENTION

1. Field of the Invention

The present invention generally relates to the manufacture of semiconductor devices, and more particularly, the present invention relates chemical vapor deposition (CVD) methods which are used to deposit metal layers, such as ohmic layers and barrier layers, during the manufacture of semiconductor devices.

2. Description of the Related Art

As the dimensions of semiconductor devices continues to decrease, the aspect ratio (height-to-width ratio) of contact holes contained in multilayer interconnections of the devices has increased, thus making it difficult to fill the contact holes will metal materials and the like. One technique used to enhance fill characteristics is to line the contact holes with an ohmic layer and a barrier layer. The ohmic layer is intended to reduce contact resistance of the metal fill material, and the barrier layer is intended to avoid diffusion of the metal material into the underlying structure. Typically, for example, a Ti ohmic layer and a TiN barrier layer are sequentially deposited to conform to the inside surface of a contact hole, and then the contact hole is filled with an upper-layer interconnection material or a metal contact plug. Filling is often achieved by high-temperature sputtering of an aluminum-based metal, or by blanket or selective CVD of tungsten.

In order to deposit the Ti and/or TiN layers, reactive sputtering and sputtering using a Ti metal target have been commonly adopted. Unfortunately, however, conventional sputtering techniques do not perform well in the case of contact holes having high aspect ratios.

As such, plasma CVD techniques using TiCl₄ source gas have more recently been adopted in an effort to enhance step coverage, particularly in the case of contact holes having high aspect ratios. However, plasma processes can induce damage to underlying semiconductor circuit devices. For example, field effect transistor (FET) devices having thin gate oxides are particularly vulnerable to plasma induced damage. Subjecting such devices to the plasma deposition processes used to form Ti ohmic layers and/or TiN barrier layers can damage gate oxides, thereby reducing process yields.

### SUMMARY OF THE INVENTION

According to one aspect of the present invention, a chemical vapor deposition (CVD) method is provided for depositing a metal layer. The method includes pre-injection of a metal source gas into a chamber. containing a substrate, and thereafter forming a plasma in the chamber to deposit the metal layer on the substrate.

According to another aspect of the present invention, a CVD method is provided for depositing a metal layer. The method includes supplying both a purge gas and a reduction gas into a chamber containing a substrate during each of successive first, second and third time intervals, supplying a metal source gas into the chamber during at least each of the successive second and third time intervals, and forming a plasma in the chamber during the third time interval and not during the second time interval, where the metal layer is deposited on the substrate during the third time interval.

According to yet another aspect of the present invention, a CVD method is provided for depositing a metal layer. The method includes placing a substrate into a chamber, where the substrate includes an insulating layer extending over a surface of the substrate, and where the insulating layer has an opening which exposes a conductive portion of the substrate, pre-injecting a metal source gas into the chamber containing the substrate, and thereafter forming a plasma in the chamber to deposit the metal layer on the conductive portion of the substrate.

According to still another aspect of the present invention, a CVD method is provided for depositing a metal layer. The method includes placing a substrate into a chamber, where the substrate includes an insulating layer extending over a surface of the substrate, and where the insulating layer has an opening which exposes a conductive portion of the substrate, supplying both a purge gas and a reduction gas into the chamber containing the substrate during each of successive first, second and third time intervals, supplying a metal source gas into the chamber during at least the successive second and third time intervals, and forming a plasma in the chamber during the third time interval and not during the second time interval, where the metal layer is deposited on the conductive portion of substrate during the third interval.

### BRIEF DESCRIPTION OF THE DRAWINGS

The above and other aspects and features of the present invention will become readily apparent from the detailed description that follows, with reference to the accompanying drawings, in which:

FIG. 1 is a process flow chart for use in describing a method of manufacturing a semiconductor device according to an embodiment of the present invention;

FIGS. 2A through 2E are cross-sectional views for use in describing the method illustrated in the process flow chart of FIG. 1;

FIG. 3 is a timing diagram illustrating the introduction of gases and the application of RF power and heat according to a plasma CVD method of an embodiment of the present invention;

FIG. 4 is a timing diagram illustrating the introduction of gases and the application of heat according to a thermal CVD method of an embodiment of the present invention;

FIGS. 5 and 6 schematically illustrate gate oxide failures of wafers in plasma CVD methods where a metal source gas is introduced either simultaneously with or after the application of RF power; and

FIGS. 7 and 8 schematically illustrate gate oxide failures of wafers in plasma CVD methods where a metal source gas is pre-injected prior to the application of RF power.

### DETAILED DESCRIPTION OF PREFERRED EMBODIMENTS

When a plasma chemical vapor deposition (CVD) method is used to deposit a metal layer, such as an ohmic layer and/or a barrier layer within a contact hole, the present inventors have discovered that process yields can be unexpectedly and substantially improved by pre-injection of metal source gas into the CVD chamber prior to formation of plasma in the chamber. This is contrary to the conventional plasma CVD methods in which the metal source gas is introduced simultaneously with or after the plasma is formed.

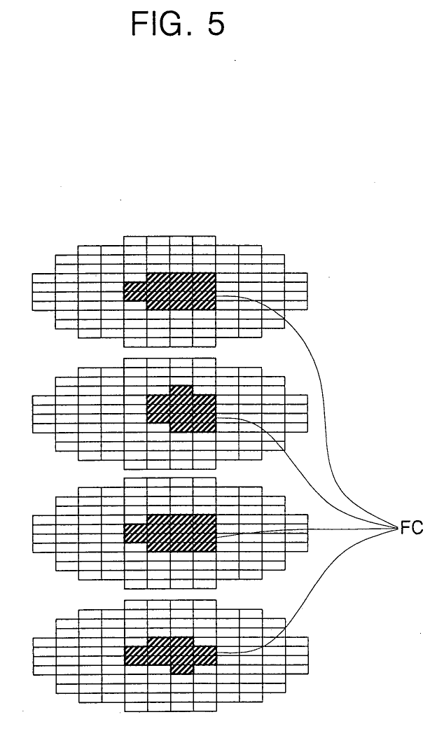

For example, as will be explained later with reference to FIGS. 5 through 8, damage to the gate oxides of FET devices can be significantly reduced or even eliminated by pre-injection of the metal source gas prior to application of RF power to the chamber. The invention is not to be limited by theory, but it is believed that the pre-injection of the metal source gas absorbs into and/or coats the surface of the contact hole or layer, thus reducing the damaging impact of the plasma generated when RF power is applied. Alternately, or in addition, the metal source gas within the chamber may have an attenuating effect on the plasma itself when it is initially formed, thus reducing damage to underlying devices. Again, however, the invention is not limited to these theoretical explanations of the advantageous effects resulting from pre-injection of the metal source gas.

Pre-injection of the metal source gas is particularly useful when plasma CVD is used to deposit a metal ohmic layer and/or a metal barrier layer within a contact hole having a high aspect ratio. The favorable step coverage characteristics of the plasma CVD process can be obtained without sacrificing device yields which would otherwise result from plasma induced damage to underlying devices.

The present invention will now be described by way of several preferred but non-limiting embodiments.

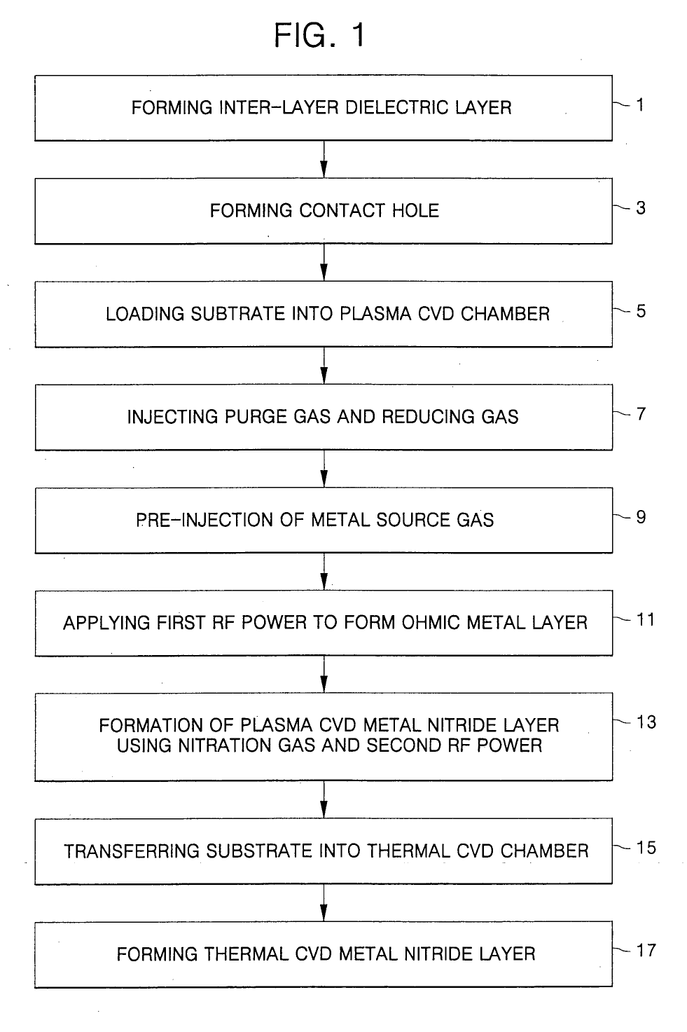

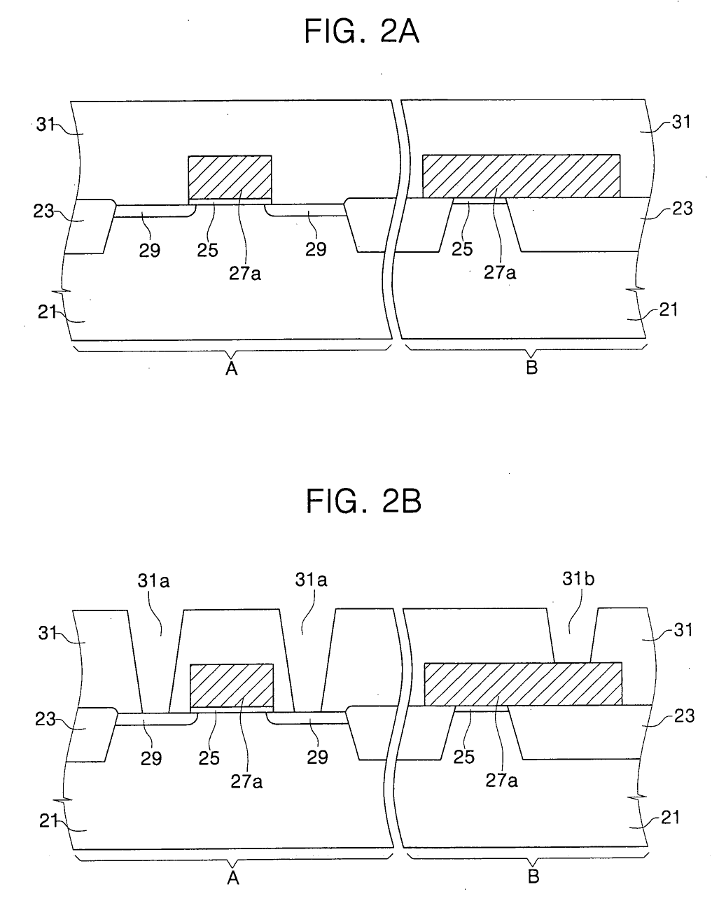

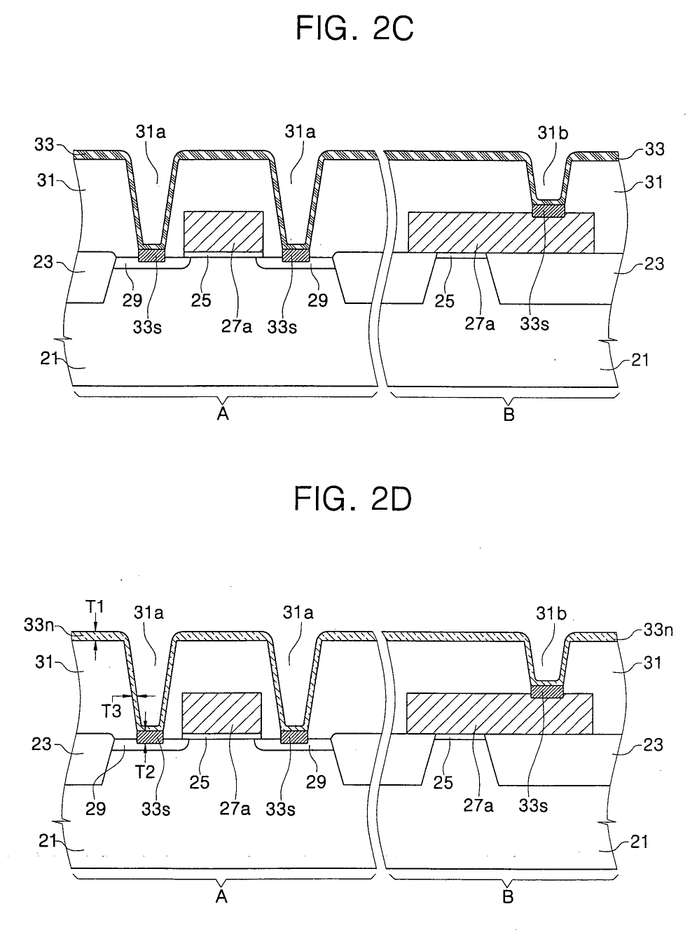

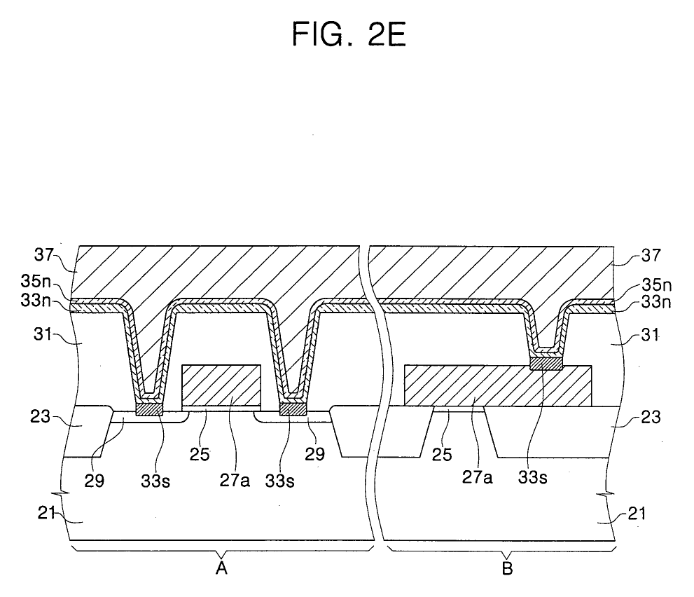

A method of manufacturing a semiconductor device according to an embodiment of the present invention will be described with reference to the process flow chart of FIG. 1 and the cross-sectional views of FIGS. 2A through 2E. In FIGS. 2A through 2E, the device section “A” is a cross-sectional view in a gate width direction, and device section “B” is a cross-sectional view in a gate length direction.

A first step in the process of this embodiment is the formation of an inter-layer dielectric layer (step 1 of FIG. 1). That is, as shown in FIG. 2A, an inter-layer dielectric layer 31 is deposited over a gate electrode 27a and the surface of a semiconductor substrate 21. Device isolation regions 23 define an active region of the substrate 21. Source/drain regions 29 are contained within the active region of the substrate 21, and a gate oxide layer 25 is interposed between the gate electrode 27a and the active region of the substrate 21. The gate electrode 27a, the source/drain regions 29, and the gate oxide 25 define an MOS transistor.

The inter-layer dielectric layer 31 is then patterned to form contact holes therein (step 3 of FIG. 1). This is illustrated in FIG. 2B where contact holes 31a and 31b are defined through the inter-layer insulating layer 31. Specifically, contact holes 31a expose the source/drain regions 29, and contact hole 31b exposes an upper surface of the gate electrode 31b.

The substrate structure illustrated in FIG. 2B is then loaded into a CVD chamber (step 5 of FIG. 1) where it is heated, for example, to a temperature of about 600° C. to about 650° C. After heating, a purge gas and a reduction gas are injected into the chamber (step 7 of FIG. 1), and preferably after a given period of time, a metal source gas is pre-injected into the chamber (step 9 of FIG. 1). In the example of this embodiment, the reduction gas is hydrogen (H₂), the purge gas is argon (Ar), and the metal source gas is titanium quadri-chloride (TiCl₄).

A given period of time after the metal source gas is injected, a plasma is created in the chamber by application of RF power to the chamber (step 11 of FIG. 1), which results in the formation of an ohmic layer within the contact holes 31a and 31b and on an upper surface of the inter-layer insulating layer 31. Note here that “pre-injection” of the metal source gas means that the metal source gas is introduced into the chamber before plasma is formed in the chamber. The ohmic layer is illustrated in FIC. 2C by reference number 33. Also, as shown in the same figure, silicide layers 33s are simultaneously formed as a result of the aforementioned heat treatment at the interface between the ohmic layer 33 and the source/drain regions 29 and the gate electrode 27a. In the example of this embodiment, the ohmic layer 33 is a titanium (Ti) layer, and the silicide layers are titanium silicide (TiSₓ) layers.

In the case where the metal source gas is TiCl₄, chlorine residue tends to form on the ohmic layer 33. The chlorine can diffuse into and corrode a subsequently formed metal layer (e.g., an aluminum or aluminum alloy layer), thus degrading device reliability. As such, to remove residual chloride, the ohmic layer 33 is subjected to a nitration process (step 13 of FIG. 1). Here, a nitration gas is introduced into the CVD chamber, and a second RF power is supplied to form a plasma in the chamber. As a result, a nitrified ohmic layer 33n is formed as shown in FIG. 2D. In this example, the nitration gas is NH₃, and the nitrified ohmic layer 33n is a TiN layer.

The substrate structure illustrated in FIG. 2D is then transferred to a thermal CVD chamber (step 15 of FIG. 1). A thermal CVD process is then carried out in which a nitration gas and a metal source gas are thermally reacted. In the example of this embodiment, the nitration gas is NH₃ gas and/or N₂ gas, the metal source gas is TiCl₄, and the reaction temperature is at least 650° C. The result is the formation of a barrier metal nitride layer 35n as shown in FIG. 2E. In this example, the barrier metal nitride layer 35n is a TiN layer.

Finally, as shown in FIG. 2E, a metal layer 37 is formed over the surface of the substrate 21 so as to fill the contact holes in the inter-layer insulating layer 31. The metal layer 37 may, for example, include aluminum or tungsten.

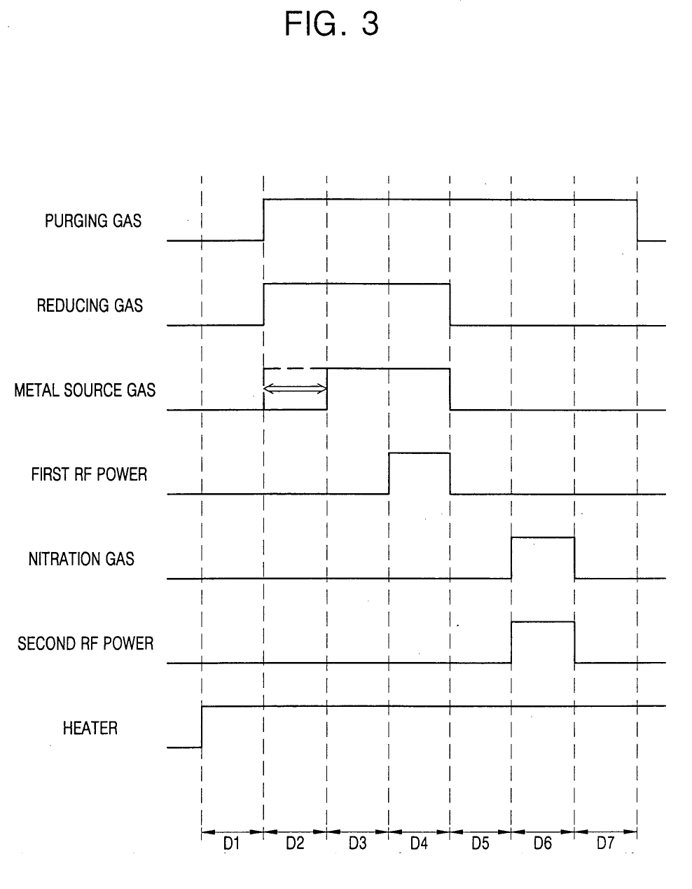

The plasma CVD formation of the nitrified ohmic layer will now be described in greater detail with reference to the timing diagram of FIG. 3. In this figure, D1, D2, . . . , D7 denote successive time intervals which are not necessarily of equal duration.

In time interval D1, heat is applied in the plasma CVD chamber to heat the semiconductor substrate (see FIG. 2B) to a given temperature. In this example, the substrate is heated to a temperature of 600° C. to 650° C. This temperature is preferably maintained throughout the plasma CVD process as shown in FIG. 3.

In time interval D2, the purge gas and the reduction gas are injected into the CVD chamber, and then, in time interval D3, the metal source gas is injected into the CVD chamber. Alternately, as shown in FIG. 3, the metal source gas may be injected simultaneously with the purge gas and reduction gas (in which case, the time intervals D2 and D3 may be considered a single time interval).

A period of time after the metal source gas is introduced, a first RF power is applied to the CVD chamber in time interval D4. As a result, a plasma is formed in the chamber, and the ohmic contact layer is formed (see, e.g., layer 33 of FIG. 2C). Note here that the first RF power is applied after the metal source gas is introduced. Preferably, the metal source gas is pre-injected at least 2 seconds prior to application of the first RF power, and more preferably, the metal source gas is pre-injected at least 5 seconds prior to the application of the first RF power. In the example of this embodiment, the reduction gas is hydrogen (H₂), the purge gas is argon (Ar), the metal source gas is titanium quadri-chloride (TiCl₄), and the ohmic layer is a Ti layer.

In time interval D5, the injection of the reduction gas and metal source gas is stopped, and application of the first RF power is halted.

Then, in time interval D6, a nitration process is performed on the ohmic layer by injecting a nitration gas into the CVD chamber and applying a second RF power. As a result, the ohmic layer becomes a nitrified ohmic layer (e.g., layer 33n of FIG. 2D). In this example, the nitration gas is NH₃, and the nitrified ohmic layer is a TiN layer.

In time interval D7, injection of the nitration gas is stopped and application of the second RF power is halted, and residual gases are removed from the chamber using the purge gas.

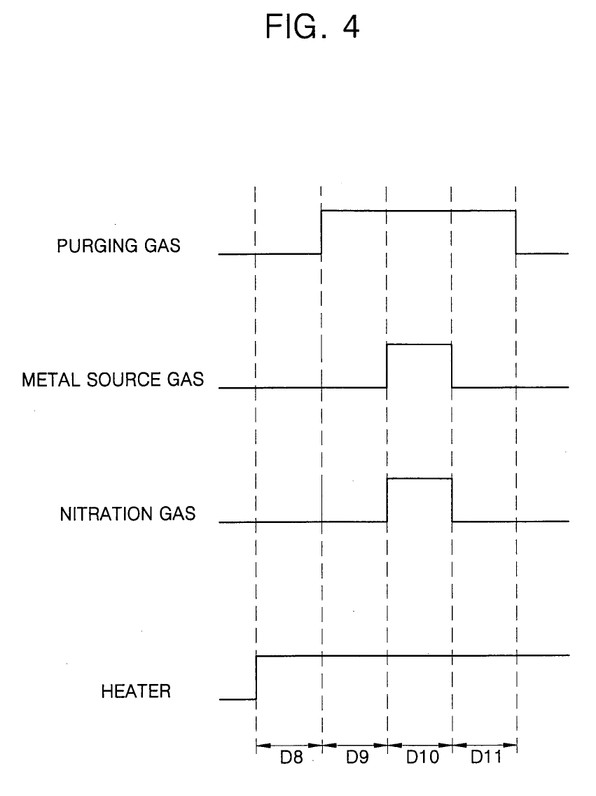

The thermal CVD formation of the barrier metal nitride layer will now be described in greater detail with reference to the timing diagram of FIG. 4. In this figure, D8, D9, . . . , D11 denote successive time intervals which are not necessarily of equal duration.

In time interval D8, heat is applied in the thermal CVD chamber to heat the semiconductor substrate (see FIG. 2D) to a given temperature. In this example, the substrate is heated to a temperature of 650° C. or more. As shown in FIG. 4, this temperature is preferably maintained throughout the thermal CVD process.

In time interval D9, a purge gas (e.g., Ar) is injected into the CVD chamber, and in time interval D10, a metal source gas and a nitration gas are injected into the CVD chamber. As a result, the barrier metal nitride layer is formed (see, e.g., layer 35n of FIG. 2E). In the example of this embodiment, the nitration gas is NH₃ gas and/or N₂ gas, the metal source gas is TiCl₄, and the barrier metal nitride layer is a TiN layer.

In time interval D11, injection of the nitration gas and metal source gas is stopped, and residual gases are removed from the chamber using the purge gas.

Advantageous effects of the present invention will now be described by way of experimental results.

Four sets of sample devices where prepared according to the parameters shown in Table A below.

TABLE A

| | Plasma CVD of | | Thermal CVD of |
|---|---|---|---|
| | Ti layer | Nitration | TiN layer |
| Substrate temperature | 650 | 650 | 700 |
| The flow rate of Ar | 2000 SCCM | 2000 SCCM | — |
| The flow rate of H2 | 4000 SCCM | — | — |
| The flow rate of | 12 SCCM | — | 10 SCCM/60 |
| TiCl4 | | | SCCM |
| RF power | 800 W | 1200 W | — |
| The flow rate of NH3 | — | 1500 SCCM | 60 SCCM |
| The flow rate of N2 | — | — | 510 SCCM |

As shown in Table B below, each sample set differed from the others with respect to the timing at which the metal source gas (TiCl₄) was introduced relative to the application of RF power.

TABLE B

| Metal source gas injected | | | |
|---|---|---|---|
| simultaneously with or after | | Metal source gas pre-injected prior to | |
| application of RF power | | application of RF power | |
| Sample 1 | Sample 2 | Sample 3 | Sample 4 |
| Plasma formed | Plasma formed by | Injection of TiCl4 | Injection of TiCl4 |
| by application | application of RF | gas | gas |
| of RF power | power | | |
| 5 second lapse | 0 second lapse of | 2 second lapse of | 5 second lapse of |
| of time | time | time | time |
| Injection of | Injection of TiCl4 | Plasma formed by | Plasma formed by |
| TiCl4 gas | gas | application of RF | application of RF |
| | | power | power |

FIG. 5 illustrates wafer maps showing the experimental results associated with sample 1, in which the metal source gas was introduced 5 seconds after the plasma was formed. The darkened chip regions FC of FIG. 5 denote “failed chips” which exhibited an abnormally low gate oxide breakdown voltage. A low breakdown voltage is indicative of a damaged, or excessively thin, gate oxide.

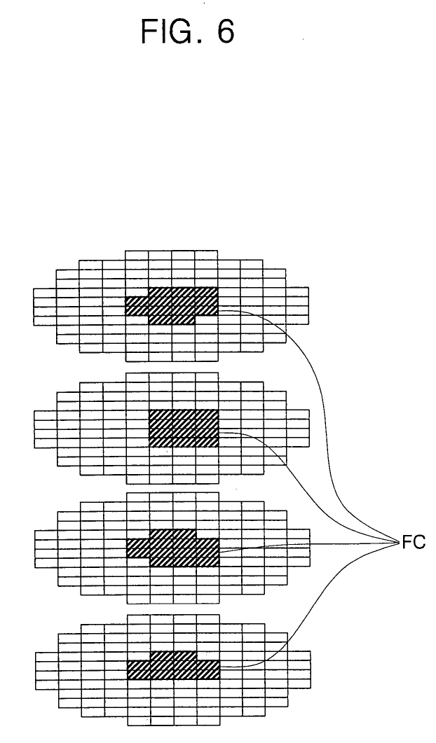

FIG. 6 illustrates wafer maps showing the experimental results associated with sample 2, in which the metal source gas was introduced at the same time the plasma was formed. Again, the darkened chip regions FC of FIG. 6 denote “failed chips” which exhibited an abnormally low gate oxide breakdown voltage.

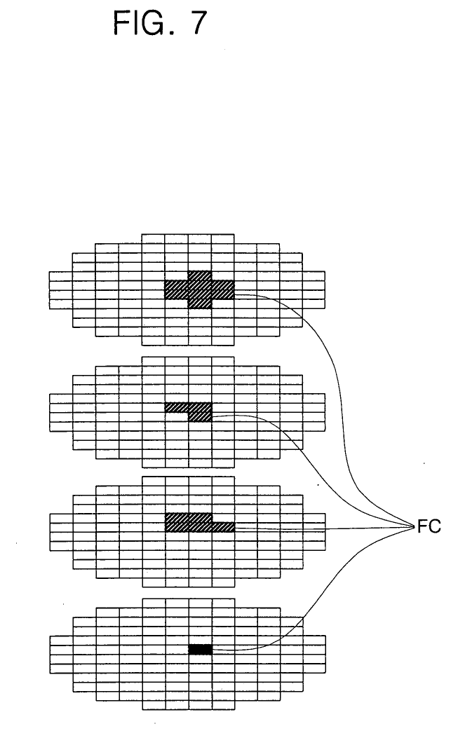

FIG. 7 illustrates wafer maps showing the experimental results associated with sample 3, in which the metal source gas was introduced 2 seconds before the plasma was formed. Once again, the darkened chip regions FC of FIG. 7 denote “failed chips” which exhibited an abnormally low gate oxide breakdown voltage.

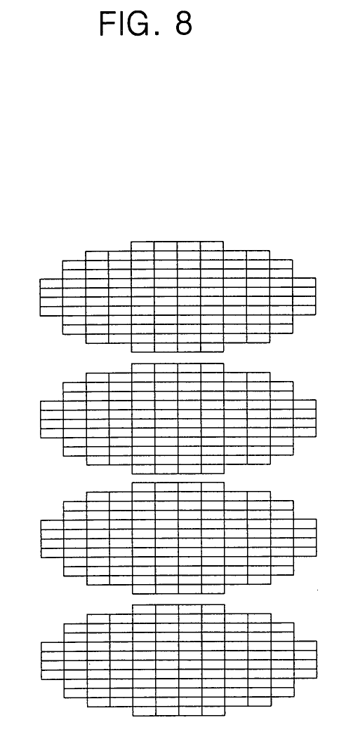

FIG. 8 illustrates wafer maps showing the experimental results associated with sample 1, in which the metal source gas was introduced 5 seconds before the plasma was formed.

As is readily apparent from a comparison of FIG. 7 with FIGS. 5 and 6, the occurrence of chip failures is significantly reduced by pre-injection of the metal source gas 2 seconds prior to formation of the plasma within the CVD chamber. Further, as shown in FIG. 8, there was no occurrence of chip failures when the metal source gas was pre-injected 5 seconds prior to formation of the plasma within the CVD chamber.

As such, when depositing a metal layer using the plasma CVD method according to the present invention, process yields can be unexpectedly and substantially improved by pre-injection of metal source gas into the CVD chamber prior to formation of plasma in the chamber.

Although the present invention has been described above in connection with the preferred embodiments thereof, the present invention is not so limited. Rather, various changes to and modifications of the preferred embodiments will become readily apparent to those of ordinary skill in the art. Accordingly, the present invention is not limited to the preferred embodiments described above. Rather, the true spirit and scope of the invention is defined by the accompanying claims.

What is claimed is:

1. A chemical vapor deposition (CVD) method for depositing a metal layer, comprising pre-injection of a metal source gas into a chamber containing a substrate, and thereafter forming a plasma in the chamber to deposit the metal layer on the substrate.

2. The CVD method of claim 1, wherein the pre-injection of the metal source gas occurs at least two seconds prior to the formation of the plasma in the chamber.

3. The CVD method of claim 1, wherein the pre-injection of the metal source gas occurs at least five seconds prior to the formation of the plasma in the chamber.

4. The CVD method of claim 1, wherein the plasma is formed by application of RF power to the chamber.

5. The CVD method of claim 1, wherein the metal source gas comprises titanium.

6. The CVD method of claim 1, wherein the metal source gas is a TiCl₄ gas.

7. The CVD method of claim 1, wherein the metal source gas comprises tungsten nitride or tantalum nitride.

8. The CVD method of claim 1, wherein the metal layer is deposited on a conductive silicon region of the substrate.

9. The CVD method of claim 8, wherein the conductive silicon region is a source/drain region of the substrate.

10. The CVD method of claim 8, wherein the conductive silicon region is a poly-silicon electrode of the substrate.

11. The CVD method of claim 8, further comprising heating the substrate during formation of the plasma to form a metal silicide layer between the conductive silicon region and the metal layer.

12. The CVD method of claim 11, wherein the metal silicide layer is a titanium silicide layer, and the metal layer is a titanium layer.

13. The CVD method of claim 12, further comprising depositing a titanium nitride layer over the titanium layer using a thermal CVD process.

14. A chemical vapor deposition (CVD) method for depositing a metal layer, comprising:
supplying both a purge gas and a reduction gas into a chamber containing a substrate during each of successive first, second and third time intervals;
supplying a metal source gas into the chamber during each of the successive second and third time intervals; and
forming a plasma in the chamber during the third time interval and not during the second time interval, wherein the metal layer is deposited on the substrate during the third time interval.

15. The CVD method of claim 14, wherein the second time interval is at least 2 seconds.

16. The CVD method of claim 14, wherein the second time interval is at least 5 seconds.

17. The CVD method of claim 14, wherein the plasma is formed by application of RF power to the chamber.

18. The CVD method of claim 14, wherein the metal source gas comprises titanium.

19. The CVD method of claim 14, wherein the metal source gas is a TiCl₄ gas.

20. The CVD method of claim 14, wherein the metal source gas comprises tungsten nitride or tantalum nitride.

21. The CVD method of claim 14, wherein the metal layer is deposited on a conductive silicon region of the substrate.

22. The CVD method of claim 21, wherein the conductive silicon region is a source/drain region of the substrate.

23. The CVD method of claim 21, wherein the conductive silicon region is a poly-silicon electrode of the substrate.

24. The CVD method of claim 21, further comprising heating the substrate during formation of the plasma to form a metal silicide layer between the conductive silicon region and the metal layer.

25. The CVD method of claim 24, wherein the metal silicide layer is a titanium silicide layer, and the metal layer is a titanium layer.

26. The CVD method of claim 25, further comprising depositing a titanium nitride layer over the titanium layer using a thermal CVD process.

27. The CVD method of claim 14, further comprising heating the substrate during the first, second and third intervals.

28. The CVD method of claim 27, wherein the substrate is heated to a temperature range of 600° C. to 650° C.

29. The CVD method of claim 27, further comprising ceasing the supply of the reduction gas and the metal purge gas and ceasing the formation of the plasma during a fourth time interval which succeeds the third time interval, and then supplying a nitration gas and forming another plasma during a fifth time interval which succeeds the fourth time interval, wherein the supply of the purge gas and the heating of the substrate are maintained during the fourth and fifth time intervals.

30. The CVD method of claim 14, wherein the metal source gas is also supplied to the chamber during the first time interval.

31. The CVD method of claim 14, wherein the purge gas is an argon gas.

32. The CVD method of claim 14, wherein the reduction gas is a hydrogen gas.

33. A chemical vapor deposition (CVD) method for depositing a metal layer, comprising:
placing a substrate into a chamber, wherein the substrate includes an insulating layer extending over a surface of the substrate, and wherein the insulating layer has an opening which exposes a conductive portion of the substrate; and
pre-injecting a metal source gas into the chamber containing the substrate, and thereafter forming a plasma in the chamber to deposit the metal layer on the conductive portion of the substrate.

34. The CVD method of claim 33, wherein the pre-injection of the metal source gas occurs at least two seconds prior to the formation of the plasma in the chamber.

35. The CVD method of claim 33, wherein the pre-injection of the metal source gas occurs at least five seconds prior to the formation of the plasma in the chamber.

36. A chemical vapor deposition (CVD) method for depositing a metal layer, comprising:
placing a substrate into a chamber, wherein the substrate includes an insulating layer extending over a surface of the substrate, and wherein the insulating layer has an opening which exposes a conductive portion of the substrate;
supplying both a purge gas and a reduction gas into the chamber containing a substrate during each of successive first, second and third time intervals;
supplying a metal source gas into the chamber during at least the successive second and third time intervals; and
forming a plasma in the chamber during the third time interval and not during the second time interval, wherein the metal layer is deposited on the conductive portion of substrate during the third interval.

37. The CVD method of claim 36, wherein the second time interval is at least 2 seconds.

38. The CVD method of claim 36, wherein the second time interval is at least 5 seconds.
